(19) United States
(12) Patent Application Publication
(10) Pub. No.: US 2008/0138632 A1
(43) Pub. Date: Jun. 12, 2008

(54) INFORMATION CARRIER PRECURSOR AND INFORMATION CARRIER PRODUCED THEREWITH

(75) Inventor: Luc Leenders, Herentals (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: AGFA-GEVAERT, Mortsel (BE)

(21) Appl. No.: 11/738,068

(22) Filed: Apr. 20, 2007

Related U.S. Application Data
(60) Provisional application No. 60/869,602, filed on Dec. 12, 2006.
(60) Provisional application No. 60/869,607, filed on Dec. 12, 2006.
(60) Provisional application No. 60/869,609, filed on Dec. 12, 2006.
(60) Provisional application No. 60/908,523, filed on Mar. 28, 2007.

(30) Foreign Application Priority Data
Dec. 7, 2006 (EP) 06125552.7
Dec. 7, 2006 (EP) 06125555.0
Dec. 7, 2006 (EP) 06125558.4
Mar. 27, 2007 (EP) 07104951.4

(51) Int. Cl. B32B 9/04; B05D 1/36; B05D 3/00

(52) U.S. Cl. 428/446; 427/372.2; 427/402; 428/411.1; 428/688

(57) ABSTRACT

Receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer; an information carrier precursor comprising the above-mentioned receiving layer configuration and a rigid sheet or a support; a method for producing an information carrier comprising the steps of: providing the above-mentioned information carrier precursor; and printing an image or pattern on the receiving layer configuration of the information carrier precursor by a conventional printing process using at least one liquid printing ink; and an information carrier obtained according to the above-mentioned process.

### CROSS-REFERENCE TO RELATED PATENT APPLICATIONS

This application claims the benefit of U.S. Provisional Application No. 60/869,602 filed Dec. 12, 2006; U.S. Provisional Application No. 60/869,607 filed Dec. 12, 2006; U.S. Provisional Application No. 60/869,609 filed Dec. 12, 2006; and U.S. Provisional Application No. 60/908,523 filed Mar. 28, 2007, which are all incorporated by reference. In addition, this application claims the benefit of European Application No. 06125552 filed Dec. 7, 2006; European Application No. 06125555 filed Dec. 7, 2006; European Application No. 06125558 filed Dec. 7, 2006; and European Application No. 07104951 filed Mar. 27, 2007, which are all also incorporated by reference.

### FIELD OF THE INVENTION

The present invention relates to a receiving layer configuration comprising luminescent fibres and/or luminescent beads, an information carrier precursor comprising luminescent fibres and/or luminescent beads, a method for producing the information carrier and the information carriers produced therewith.

### BACKGROUND OF THE INVENTION

The security field encompasses not only personalized documents such as passports, driving licenses, identity cards (ID cards) and admission documents such as visa's and entry tickets, but also the authentification and identification of goods to avoid counterfeiting, tampering and fraud such as lottery tickets, share certificates, transaction documents, labels on luggage and the packaging of pharmaceuticals and high value products in general.

The term “identity card” encompasses cards requiring bearer identification and range from national identity cards to establish the national identity of their civilians to cards involved in the electronic transfer of money such as bank cards, pay cards, credit cards and shopping cards to security cards authorizing access to the bearer of the card to particular areas such as a company (employee ID card), the military, a public service, the safe deposit departments of banks, etc. to social security cards to membership cards of clubs and societies.

The first type of information may be general information such as a name and/or logo of the issuing authority, or security marks, such as a watermark and security print, e.g. a repeating monochrome pattern or a gradually changing colour pattern which are difficult to counterfeit. The second type includes e.g. the unique card number, personal data such as a birth day, a photo of the owner, and a signature. The card can further contain hidden information and therefore contain a magnetic strip or an electronic chip (“smart cards”). The information contained in an identification document is either human-readable, i.e. visible either directly or with the assistance of a magnifying or non-visible light sources, or is machine readable.

A large set of ID cards are usually prepared on a large carrier of information such as a web or sheet by a step and repeat process, after which the information carrier is cut into multiple items with the appropriate dimensions each representing a personal ID card. Smart cards and ID cards have now the standardized dimensions of 85.6 mm×54.0 mm×0.76 mm.

Normally, the card is protected by a plastic sheet material for example by lamination of the card to a plastic sheet or, as is usually the case, by lamination between two plastic sheets.

In view of their widespread uses, particularly in commercial transactions such as cashing cheques, credit purchases etc., it is important that the person relying on the ID card to identify the bearer have maximum assurance that the ID card has not been altered and/or that the ID card is not a counterfeit.

The art's response to the counterfeiting problem has involved the integration of “verification features” with ID cards to evidence their authenticity. The best known of these “verification features” involve signatures such as the signature of the one authorized to issue the ID card or the signature of the bearer. Other “verification features” have included the use of watermarks, fluorescent materials, validation patterns or markings and polarizing stripes. These “verification features” are integrated into ID cards in various ways and they may be visible or invisible in the finished card. If invisible, they can be detected by viewing the feature under conditions which render it visible. Details relating to the use of “verification features” in ID cards can be found in U.S. Pat. No. 2,984,030, U.S. Pat. No. 3,279,826; U.S. Pat. No. 3,332,775, U.S. Pat. No. 3,414,998, U.S. Pat. No. 3,675,948, U.S. Pat. No. 3,827,726 and U.S. Pat. No. 3,961,956.

GB 713,351 discloses a method of manufacturing safety paper sensitive to all chemical reagents particularly suitable for cheques, paper currency and the like, characterised by the fact that it consists in producing a special type of mottling obtained by adding only a very small amount of fibres of the same colour as the base of the paper, which fibres have been previously treated with fluorescent substances which are specially sensitive to the chemical reagents which either cause disappearance of the mottling or produce colourings or spots easily visible when illuminated under black light 45 2 A method according to claim 1 characterised by the fact that the fibres used for the mottling are cellulose fibres, natural or artificial fibres, animal fibres or the like.

EP 0 322 331B1 discloses an official document for personal use, of the type containing at least imprints relating to the identity of its owner, such as an identity card, a vehicle registration certificate, of the type having: a paper base (2) which is covered on at least one of its sides with the following successive coatings: a heat-meltable film (5); a photographic coating (6); characterized in that the photographic coating (6) is formed from a direct positive film whereof the photosensitive substance (7) is placed on the paper base (2) side. In a preferred embodiment the paper base (2) has at least one means making it possible to check its authenticity selected from the following group: watermark, safeguarding thread, fluorescent fibres, iridescent print, micro-line text, rotogravure, an imprint produced using a visible or invisible fluorescent ink.

U.S. Pat. No. 4,157,784 discloses a valuable security and the like, having safeguard elements against forgery or falsification which can be mechanically examined using light of the visible, ultraviolet, or infrared spectral regions and which are effective, particularly, against erasure, and carrying the ink-impressed information print, said valuable security and the like comprising, in combination, a paper; and a homogeneous protective coating on the paper; the paper, the protective coating and the printing ink having respective light-detectable properties selected from the group consisting of reflectance and fluorescence properties; the respective light-detectable properties of the paper, the protective coating and the printing ink being such that any damage to the protective coating is detectable at a preselected wavelength of light; the reflectance of the protective coating at the wavelength used to read the information print being considerably greater than the reflectance of the printing ink, and the reflectances of the protective coating and the printing ink, at a different wavelength, being substantially equal, while the reflectances of the paper and the protective coating at said different wavelength differ measurably from each other.

U.S. Pat. No. 4,527,051 discloses a security document such as a credit or identification card comprising means for modulating passage of energy in waveform through at least a portion of said document; the modulating means being randomly distributed in said portion of said document; said document further comprising means for emitting, transmitting or reflecting wave energy arranged along a line; said wave energy emission, transmissions or reflections being detectable along said line from the card exterior and through the modulating means for providing reproducible signals; said line being of such width and said modulating means random distribution being such that successive detections of energy emissions, transmissions or reflections along the length of said line result in a reproducible, modulated signal which is unique to the line and document with which associated. In a preferred embodiment the means arranged in the line-like track comprise randomly distributed fluorescent particles which vary in size and in their distance from each other.

U.S. Pat. No. 4,387,112 discloses a process for identifying an article, which comprises: (a) applying a finely divided inorganic phosphor to said article, (b) exciting said phosphor to store energy therein by means of light free of infrared wavelengths, (c) observing any spontaneous decay phosphorescence of said phosphor in a darkened ambient, (d) stimulating said phosphor with infrared radiation, said stimulating producing an observable change in release of the previously stored energy, (e) observing the change in release of the previously stored energy as a change in luminescence of said phosphor as a result of said infrared stimulation.

U.S. Pat. No. 4,863,783 discloses paper embodying for purposes of identification granules comprising 3 to 5 micron pigment particles chemically bound together by a cross-link binder, inconspicuous in daylight but visible on inspection in darkened surroundings or after illumination at predetermined wavelength from an artificial source, wherein the granules are of 30 to 500 microns particle size and, to secure contrast between the pigment and background in said inspection, said granules are essentially free of finer particles.

U.S. Pat. No. 6,861,012 discloses a latent security marking formulation, comprising: a phosphor pigment having at least two distinct emission wavelength characteristics and particles cropped to particles of a resin binder, wherein at least one of said emission wavelength characteristics comprises fluorescent emission of light at a visible wavelength in response to excitation by irradiation of the pigment at an invisible wavelength, and wherein the phosphor pigment is provided with a particle size smaller than a predetermined maximum size for inkjet printing; and a volatile vehicle for carrying the pigment, wherein the formulation comprises 1% to 5% by weight of the pigment, wherein the pigment has distinct fluorescent responses at least at two excitation wavelengths, said distinct responses including different emission spectra responsive to said two excitation wavelengths.

U.S. Pat. No. 6,146,032 discloses a method for printing an identification card, comprising: printing an image on a substantially flat surface of the identification card; depositing a first overlayer on the surface of the identification card; creating ridges in the first overlayer on the substantially flat subsequent to the step of depositing the first layer; and depositing a second overlaminate layer over the first overlayer subsequent to the step of creating ridges, the second laminate layer having ridges created by the ridges in the first overlayer; wherein the ridges create a visible pattern on the identification card. U.S. Pat. No. 6,146,032 further discloses that the overlay panels can have brightly fluorescent characteristics.

U.S. Pat. No. 7,063,264 discloses a method for manufacturing an identification document, comprising: providing a thermal transfer printing medium comprising a first panel, the first panel comprising a color component that is not visible to the human eye in ambient light but is visible to the human eye when viewed using a first type of light, and wherein the first color component comprises a thermally diffusible dye dissolved in a resin; and applying heat to a portion of the first panel so as to form a first variable indicium on a substrate, where the first variable indicium is not visible to the human eye in ambient light but is visible to the human eye when viewed using the first type of light, wherein the first variable indicium comprises a false two color image. U.S. Pat. No. 7,063,264 only discloses the use of fluorescent dyes and pigments.

US 2005/0064151A1 discloses a security document comprising: a substrate; a first security coating disposed on said substrate; and a second security coating disposed on said first security coating, wherein one of said security coatings is a solvent-sensitive coating and another of said security coatings is an abrasion-sensitive coating such that attempts at tampering with said document produce notorious indicia of such tampering on said document. US 2005/0064151A1 further discloses that the document may further comprise additional security indicia disposed either in or adjacent one of said security coatings or said substrate, the additional security indicia being selected from the group consisting of laid lines, microprinting, photochromic inks, fluorescent fibers, fluorescent inks, optical variable inks, bar codes, pantographs and secure fonts. US 2005/0064151A1 also discloses that the top surface of the document is ink-jet printable and that the presence of a paper-based upper layer permits easy printing from an ink jet printer, although it will be appreciated that other print-receptive upper layers (including plastic) could also be used, especially in situations where the substrate is specifically designed for ink jet printers, or if a solvent-based ink jet ink was used.

US 2005/0181166A1 discloses a self-adhesive or thermally bondable security document (V) that can be affixed to an article (P), characterized in that it comprises at least one medium capable of receiving print on the front side, said medium having, on its reverse side, at least one self-adhesive or thermally adhesive layer and at least one marker that emits a signal which is characteristic per se, such that, after the document (V) has been bonded by means of said layer of adhesive to the article (P), in the event of disbandment of the document (V) at least part of said marker detaches from the medium. US 2005/0181166A1 further discloses that at least part of the article (P), to which the document (V) will be affixed, may also contain at least one marker that emits a signal which is combined with the signal from the marker of said document (V), the marker preferably comprising fluorescent particles that emit fluorescence at one wavelength which combines with that emitted by fluorescent particles contained in the article (P) to which said document (V) will be affixed.

WO 2005/040496A1 discloses cardboard used in authenticity products, which comprises a fibre matrix having two surfaces, characterized in that the other surface of the fibre layer has a layer of surface sizing containing a particle-type marking agent with a particle size smaller than 50 μm, which can preferably be optically identified.

EP-A 1 362 710 discloses a method for producing a tamper proof carrier of information, said method comprising the following steps, in order: (1) providing a two-layer assemblage comprising (i) a rigid sheet or web support, and (ii) a porous opaque ink receiving layer comprising a pigment and a binder whereby either the surface of said support, or the surface of said opaque layer carries a first set of printed information, (2) printing a second set of information, different from said first set, onto said porous opaque ink receiving layer by means of ink jet printing, (3) covering totally, partially, or pattern-wise the thus obtained assemblage with a UV-curable lacquer composition, by means of coating, printing, spraying or jetting, whereby on penetration of the lacquer in said porous opaque ink receiving layer this layer becomes substantially transparent, (4) curing said lacquer composition by means of an overall UV exposure, thereby improving the adhesion between said support and said ink receiving layer, and the cohesive strength of said ink receiving layer.

EP-A 1 398 175 discloses four different embodiments of an information carrier. In the first embodiment the information carrier comprising: a rigid sheet or web support; an opaque porous receiving layer capable of being rendered substantially transparent by penetration by a lacquer, said receiving layer containing a pigment and a binder; an image provided onto and/or in said receiving layer; a cured pattern of a varnish provided onto said receiving layer provided with said image or onto and/or in said receiving layer provided with said image if said varnish is incapable of rendering said receiving layer transparent; and a cured layer of said lacquer provided on said receiving layer provided with said image and said cured pattern of said varnish, said lacquer having rendered said parts of said receiving layer in contact therewith substantially transparent, wherein said cured pattern of said varnish forms an opaque watermark. In the second embodiment the information carrier comprising: a rigid sheet or web support; an opaque porous receiving layer capable of being rendered substantially transparent by penetration by a varnish, said receiving layer containing a pigment and a binder; an image provided onto and/or in said receiving layer; a cured pattern of said varnish provided in said receiving layer provided with said image; and a cured layer of a lacquer provided onto said receiving layer provided with said image and said cured pattern of said varnish, or onto and/or in said receiving layer provided with said image and said cured pattern of said varnish if said lacquer is incapable of rendering said receiving layer transparent, said varnish having rendered said parts of said receiving layer in contact therewith substantially transparent, wherein said cured pattern of said lacquer forms a substantially transparent watermark. In the third embodiment the information carrier comprising: a rigid sheet or web support; a transparent porous receiving layer capable of being rendered substantially opaque by penetration by a lacquer, said receiving layer containing a pigment and a binder; an image provided onto and/or in said receiving layer; a cured pattern of a varnish provided onto said receiving layer provided with said image, or onto and/or in said receiving layer provided with said image if said varnish is incapable of rendering said receiving layer opaque; and a cured layer of said lacquer provided on said receiving layer provided with said image and said cured pattern of said varnish, said lacquer having rendered said parts of said receiving layer in contact therewith substantially opaque, wherein said cured pattern of said varnish forms a transparent watermark. In the fourth embodiment the information carrier comprising: a rigid sheet or web support; a transparent porous receiving layer capable of being rendered substantially opaque by penetration by a varnish, said receiving layer containing a pigment and a binder; an image provided onto and/or in said receiving layer; a cured pattern of said varnish provided in said receiving layer provided with said image; and a cured layer of a lacquer provided onto said receiving layer provided with said image and said cured pattern of said varnish, or onto and/or in said receiving layer provided with said image and said cured pattern of said varnish if said lacquer is incapable of rendering said receiving layer opaque, said varnish having rendered said parts of said receiving layer in contact therewith substantially opaque, wherein said cured pattern of said lacquer forms a substantially opaque watermark.

GB 1 073 433 discloses the method of forming an image on a porous, opaque layer comprising applying an imaging material in imagewise configuration which is of similar refractive index to the opaque layer and reducing the viscosity of said imaging material so that it flows into the pores to fill the pores of said opaque layer to render said opaque layer clear in said image areas.

U.S. Pat. No. 4,252,601 discloses an information recording kit for making transparencies for projection of information or for making photographic negatives for reproductions comprising an opaque recording material, a writing liquid for recording information on the recording material and means for applying the writing liquid on the opaque recording material in the form of transparent lines wherein said recording material comprises a transparent backing sheet and an opaque layer adhered to one surface of said backing sheet, said opaque layer comprising a finely divided particulate organic styrene resin pigment uniformly distributed throughout a polyvinylidene chloride film-forming resin binder, said writing liquid comprising a solvent for the organic styrene resin pigment, whereby when said writing liquid is applied to said opaque layer according to a pattern of information the opaque layer becomes transparent to visible light according to said pattern.

WO 81/01389A1 discloses a self-supporting microvoid-containing sheet material which is substantially insensitive to marking by the localized application of heat or pressure but which is receptive to ink, pencil, crayon or similar markings and which is adapted to being temporarily or permanently provided with markings by the application of a colorless liquid, comprising in combination: a self-supporting base sheet and, bonded over at least one side of said base sheet, a reflective opaque white to pastel layer comprising particles bonded by a binder, said particles and binder both having a refractive index in the range of 1.3 to 2.2, interconnected microvoids being present throughout said layer, characterized in that the binder:particle volume ratio being in the range of about 1:20 to 2:3, so that the particles are held in pseudo-sintered juxtaposition, the void volume of the layer being in the range of 15-70%, said binder being thermoset, and layer having an image force of at least 200 grams-force.

U.S. Pat. No. 4,499,211 discloses a microporous molded article having an open-cell structure and comprising a thermoplastic material which possesses an inherent latent structural convertibility and includes effective pores of a diameter in the range from about 0.002 to 10 μm, said thermoplastic material comprising at least about 70 percent by weight of a terpolymer which is composed of from about 20 to 80 percent by weight, relative to the total weight of the terpolymer, of copolymerized fluorinated olefin selected from the group consisting of ethylene and propylene, up to about 40 percent by weight, relative to the total weight of the terpolymer, of copolymerized olefin selected from the group consisting of ethylene and propylene, and from about 80 to 20 percent by weight, relative to the total weight of the copolymer, of copolymerized vinyl acetate, with at least 5 percent of the total proportion of acetate groups contained in the copolymer being converted by saponification into OH groups after copolymerization of the specified comonomers to form the terpolymer.

EP-A 0 390 638 discloses a base sheet comprising a layer capable of becoming, in reversible manner, transparent by contact with a liquid, resistant to a marking by localized application of pressure and/or heat, characterized by the fact that it comprises: at least one flexible sheet, at least one layer applied in aqueous form on the flexible sheet and then dried, said sheet being microporous, opaque, and containing at least non-thermoset particles, at least one binder and optionally other additives.

JP 10-157280A discloses a recording material capable of being printed repeatedly by ink jet printing without deteriorating its recording performance even in the case of using many times by incorporating mat or porous surface and a solvent receiving layer which becomes opaque when no solvent exists and transparent when solvent is received.

U.S. Pat. No. 6,364,993 discloses a laminate comprising a substrate having a first substrate surface containing an image thereon and a polymeric film laminated to said first substrate surface overlying said image, said film containing an exposed water activatable opaque layer having a thickness ranging from about 0.6 mil to about 2.0 mil, said opaque layer derived from a coating formulation comprising from about 5 to about 40 wt. % aluminum silicate and from about 60 to about 95 wt. % binder, wherein the binder comprises a mixture of solvent, butyl acetate, ethylene glycol monobutyl ether and propylene glycol.

U.S. Pat. No. 6,723,383 discloses a process for producing a dry image comprising the steps of: (a) applying an opaque coating composition to the surface of a substrate to form an opaque coating on the substrate, wherein the surface is selected from the group consisting of a light-emitting surface, a reflective surface, a glossy surface, a luminescent surface, and a combination thereof; and (b) contacting the coated substrate with a recording liquid, wherein the opaque coating composition includes an opaque coating agent comprising a polymeric polyacid and a polymeric polybase, and wherein the opaque coating contacted with the recording liquid becomes transparent as a result of the contact.

WO 04/052655A1 discloses a multi-layer opaque and matte ink-jet recording medium, suitable for recording images with dye and pigmented inks, which goes through phase change from opaque to transparent and glossy in at least one printed area to reveal the surface of a substrate and thereby provide light-emitting, reflective, glossy, metallic-looking images or to show holographic images, wherein the recording medium comprises a substrate coated with at least two chemically layers comprising: (a) a first transparent ink-receptive layer comprising a polymeric binder and a cross-linker and optionally having a plasticizer and pigment particles such as alumina and silica coated over the substrate, wherein the cross-linker comprises an azetidinium polymer or a salt thereof, and/or a polyfunctional aziridine or a salt thereof, or a polyfunctional oxazoline and metallic salts ; and (b) a second ink-receptive layer comprising an opaque or semi-opaque coating composition, wherein the opaque or semi-opaque coating composition is capable of accepting a printed image and thereby becoming semi-transparent or clearly transparent from application of ink-jet printing ink or similar inks, while presenting a light-emitting, reflective, glossy, metallic-looking or holographic or transparent image of high clarity and quality, wherein said first layer is located between said second layer and the substrate in said recording medium and the first and second layer are chemically coupled.

There is a need for the incorporation of additional security features in security documents incorporating transparentizable opaque porous layers to heighten their security.

### ASPECTS OF THE INVENTION

It is an aspect of the present invention to provide information carrier incorporating transparentizable opaque porous layers with additional security features.

It is a further aspect of the present invention to provide information carriers with additional security features, which are capable of being individualized by incorporating details of the information bearer.

Further aspects and advantages of the present invention will become apparent from the description hereinafter.

### SUMMARY OF THE INVENTION

Surprisingly it has been found that images printed on a porous receiving layer comprising at least one pigment, at least one binder and fluorescent fibres and/or fluorescent beads using a conventional printing process with at least one liquid printing ink, exhibit upon exposure to light of a wavelength at which the fluorescent fibres and/or fluorescent beads fluoresce an appearance in which the image is broken up by fluorescing spots from the fluorescent fibres and/or beads in the receiving layer.

Aspects of the present invention are realized by a receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer.

Aspects of the present invention are further realized by an information carrier precursor comprising the above-mentioned receiving layer configuration and a rigid sheet or a support. The support may be in sheet or web form.

Aspects of the present invention are further realized by a method for producing an information carrier comprising the steps of: providing the above-mentioned information carrier precursor; and printing an image or pattern on the receiving layer configuration of the information carrier precursor by a conventional printing process using at least one liquid printing ink.

Aspects of the present invention are also realized by an information carrier obtained according to the above-mentioned process.

Further aspects of the present invention are disclosed in the dependent claims.

### DETAILED DESCRIPTION

### Definitions

The term ‘porous layer”, as used in disclosing the present invention, means a layer with pores, which can be in the ingredients of the layer and/or in addition to the ingredients of the layer e.g. a layer containing a porous ingredient is a porous layer.

The terms “opaque” or “non-transparent” layer, as used in disclosing the present invention, refer to a layer where less than 10% of the incident light is allowed to pass through the layer. In a “substantially transparent” layer at least 50% of the incident visible light, preferably more than 65% and particularly preferably more than 75%, passes through the layer.

The term “luminescent fibre”, as used in disclosing the present invention, are fibres transparent to visible light, which luminesce producing visible lights upon exposure to a source of non-visible light e.g. a UV or IR light source.

The term “luminescent bead”, as used in disclosing the present invention, are beads which are transparent to visible light, which luminesce producing visible light upon exposure to a source of non-visible light e.g. a UV or IR light source and which are individually visible upon exposure to a source of non-visible light.

The term “lacquer”, as used in disclosing the present invention, means a liquid under the application conditions, which is transparent, comprises at least one polymer and/or at least one wax and/or at least one polymerizable substance (e.g. monomers and oligomers) and can solidify upon cooling, become solid upon evaporation of solvent or harden/cross-link upon exposure to heat, moisture or radiation e.g. visible light, UV-radiation and electron beams i.e. is curable.

The term “capability of being rendered substantially transparent by a lacquer”, as used in disclosing the present invention, means that the receiving layer configuration at least becomes transparent upon penetration of the lacquer. This does not exclude the realization of transparency with water or a solvent, which provide transparentization for as long as the liquid remains in the pores i.e. provides a temporary transparentization.

The terms “on”, “onto” and “in”, as used in disclosing the present invention, have very precise meanings with respect to a layer: “on” means that penetration of the layer may or may not occur, “onto” means at least 90% on the top of i.e. there is no substantial penetration into the layer, and “in” means that penetration into the respective layer or layers occurs. With printing digitally stored information “onto” a porous receiving layer configuration, we understand that an image is provided “on and/or in” the receiving layer configuration. In the case of ink jet printing, if the ink remains on top of the receiving layer configuration, the image is provided “onto” the receiving layer configuration. If the ink penetrates into the porous receiving layer configuration, it is “in” the layer. The same terminology is used for the varnish and the lacquer. For example, under “before substantial penetration of the varnish in the receiving layer configuration”, it is understood that ≦10% of the varnish is located “in” the receiving layer configuration.

The term “conventional printing process”, as used in disclosing the present invention refers to impact printing processes as well as to non-impact printing processes. The term includes but is not restricted to ink-jet printing, intaglio printing, screen printing, flexographic printing, driographic printing, electrophotographic printing, electrographic printing, offset printing, stamp printing, gravure printing, thermal and laser-induced processes and also includes a printing process rendering areas of a conductive layer non-conductive in a single pass process, such as disclosed in EP 1 054 414A and WO 03/025953A, but excludes processes such as evaporation, etching, diffusion processes used in the production of conventional electronics e.g. silicon-based electronics.

The term “impact printing process”, as used in disclosing the present invention, means a printing process in which contact is made between the medium in which the print is produced and the printing system e.g. printers in which a master is covered with an ink layer on areas corresponding to a desired image or shape, after which the ink is transferred to the medium, such as offset, gravure or flexographic printing.

The term “non-impact printing process”, as used in disclosing the present invention, means a printing process in which no contact is made between the medium in which the print is produced and the printing system e.g. electrographic printers, electrophotographic printers, laser printers, ink jet printers in which prints are produced without needing to strike the print medium.

The term ‘pattern”, as used in disclosing the present invention, includes holograms, images, representations, guilloches, graphics and regular and irregular arrays of symbols, images, geometric shapes and non-geometric shapes and can consist of pixels, continuous tone, lines, geometric shapes and/or any random configuration.

The term “pattern-wise”, as used in disclosing the present invention, means as a pattern and embraces the term image-wise.

The term “coloured image”, as used in disclosing the present invention, is an image produced with one or more colorants and which in the case of the colour black is produced by a combination of at least two colorants.

The term “colorant”, as used in disclosing the present invention, means a substance absorbing in the visible spectrum between 400 nm and 700 nm.

The term “dye”, as used in disclosing the present invention, means a colouring agent having a solubility of 10 mg/L or more in the medium in which it is applied and under the ambient conditions pertaining.

The term “pigment”, as used in disclosing the present invention, is defined in DIN 55943, herein incorporated by reference, as an inorganic or organic, chromatic or achromatic colouring agent that is practically insoluble in the application medium under the pertaining ambient conditions, hence having a solubility of less than 10 mg/L therein.

The term security print, as used in disclosing the present invention, means a printed image or pattern designed to be difficult to counterfeit and hence providing a security feature.

The term “layer”, as used in disclosing the present invention, means a coating or prints covering the whole area of and applied to the entity referred to e.g. a support.

The term “discontinuous layer”, as used in disclosing the present invention, means a coating or print not covering the whole area of and applied to the entity referred to e.g. a support.

PET is an abbreviation for polyethylene terephthalate.

PETG is an abbreviation for polyethylene terephthalate glycol, the glycol indicating glycol modifiers which are incorporated to minimize brittleness and premature aging that occur if unmodified amorphous polyethylene terephthalate (APET) is used in the production of cards.

### Receiving Layer Configuration

Aspects of the present invention are realized by a receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer. The outermost layer on said image-receiving side or a layer in diffusive contact with said outermost layer on said image-receiving side, which is opaque and porous, preferably comprises at least one pigment and at least one binder.

According to a first embodiment of the receiving layer configuration, according to the present invention, the binder is a water-soluble binder, a solvent-soluble binder or a latex.

According to a second embodiment of the receiving layer configuration, according to the present invention, the receiving layer configuration comprises at least one latex in at least one constituent layer.

According to a third embodiment of the receiving layer configuration, according to the present invention, at least one constituent layer of said receiving layer configuration comprises at least one pigment and at least one latex and the weight ratio of total pigment to total latex is in the range of 3 to 6.5.

According to a fourth embodiment of the receiving layer configuration, according to the present invention, the receiving layer configuration comprises at least two layers and each layer comprises at least one pigment and at least one binder.

According to a fifth embodiment of the receiving layer configuration, according to the present invention, the receiving layer configuration comprises at least two layers and consists at least in part of areas which are both opaque and porous and which are transparentizable upon penetration by a lacquer.

Multiple layers comprising the receiving layer configuration can be coated or printed simultaneously or sequentially and may have the same or different compositions e.g. to vary the porosity of the individual layers or to locate the at least one substance capable of and available for binding, catalyzing or reacting with at least one species diffusing through the receiving layer configuration can thereby be localized in one or more receiving layers in the receiving layer configuration, the substances in these layers being the same or different.

The receiving layer configuration may be coated onto the support by any conventional coating technique, such as dip coating, knife coating, extrusion coating, spin coating, slide hopper coating and curtain coating, and any conventional printing technique, such as screen printing, offset printing, ink-jet printing, gravure printing and intaglio printing.

The composition of individual layers in the receiving layer configuration can be modified after deposition by coating or printing by, for example, pattern-wise or non-pattern-wise deposition of a substance in a form which can mix with, e.g. upon partial dissolution of the uppermost part of the layer, or diffuse into layer. The at least one substance capable of and available for binding, catalyzing or reacting with at least one species diffusing through the receiving layer configuration can thereby be localized in one or more receiving layers in the receiving layer configuration during the application process.

According to a sixth embodiment of the receiving layer configuration, according to the present invention, one or more of the constituent layers of said receiving layer configuration comprise, optionally pattern-wise, at least one substance capable of and available for interacting in situ with at least one species diffusing through the receiving layer configuration to produce a functional species.

According to a seventh embodiment of the receiving layer configuration, according to the present invention, the receiving layer configuration further comprises at least one further ingredient from the group consisting of surfactants, hardening agents, plasticizers, whitening agents and matting agents.

### Information Carrier Precursor

Aspects of the present invention are realized by an information carrier precursor comprising a rigid sheet or a support and a receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer.

According to a first embodiment of the information carrier precursor, according to the present invention, at least one of the constituent layers of the receiving layer configuration and the optional supplementary layers further comprises at least one further ingredient from the group consisting of surfactants, hardening agents, plasticizers, whitening agents and matting agents.

### Plasticizers

The constituent receiving layers and the optional supplementary layers used in the information carrier precursor, according to the present invention, may also comprise a plasticizer such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, n-methyl-2-pyrrolidone, n-vinyl-2-pyrrolidone.

### Hardeners

According to an eighth embodiment of the receiving layer configuration, according to the present invention, at least one of the constituent layers of the receiving layer configuration is crosslinked to a degree of less than 20%, with a degree of crosslinking of less than 15% being preferred and a degree of crosslinking of less than 10% being particularly preferred.

According to an second embodiment of the information carrier precursor, according to the present invention, at least one of the constituent layers of the receiving layer configuration and optional supplementary layers is less than 20% crosslinked, with less than 15% crosslinking being preferred and less than 10% crosslinking being particularly preferred.

Such light crosslinking provides desirable features such as waterfastness and non-blocking characteristics. However, the degree of cross-linking should be such that neither the diffusion of the functional species or functional species precursor nor the penetration of the lacquer should be substantially affected. Crosslinking is also useful in providing abrasion resistance and resistance to the formation of fingerprints on the element as a result of handling.

There are a vast number of known crosslinking agents—also known as hardening agents—that will function to crosslink film forming binders. Hardening agents can be used individually or in combination and in free or in blocked form. Suitable hardeners for use in the present invention include formaldehyde and free dialdehydes, such as succinaldehyde and glutaraldehyde, blocked dialdehydes, active esters, sulphonate esters, active halogen compounds, isocyanate or blocked isocyanates, polyfunctional isocyanates, melamine derivatives, s-triazines and diazines, epoxides, active olefins having two or more active bonds, carbodiimides, zirconium complexes, e.g. BACOTE 20, ZIRMEL 1000 or zirconium acetate, trademarks of MEL Chemicals, titanium complexes, such as TYZOR grades from DuPont, isoxazolium salts substituted in the 3-position, esters of 2-alkoxy-N-carboxy-dihydroquinoline, N-carbamoylpyridinium salts, hardeners of mixed function, such as halogen-substituted aldehyde acids (e.g. mucochloric and mucobromic acids), onium substituted acroleins and vinyl sulphones and polymeric hardeners, such as dialdehyde starches and copoly(acroleinmethacrylic acid), and oxazoline functional polymers, e.g. EPOCROS WS-500, and EPOCROS K-1000 series, and maleic anhydride copolymers, e.g. GANTREZ AN119.

### Surfactants

According to a ninth embodiment of the receiving layer configuration, according to the present invention, at least one the constituent layers of said receiving layer configuration further comprises a surfactant.

According to a third embodiment of the information carrier precursor, according to the present invention, at least one of the constituent layers of the receiving layer configuration and optional supplementary layers further comprises a surfactant.

Suitable surfactants are any of the cationic, anionic, amphoteric, and non-ionic ones as described in JP-A 62-280068 (1987). Examples of suitable surfactants are N-alkylamino acid salts, alkylether carboxylic acid salts, acylated peptides, alkylsulphonic acid salts, alkylbenzene and alkylnaphthalene sulphonic acid salts, sulphosuccinic acid salts, α-olefin sulphonic acid salts, N-acylsulphonic acid salts, sulphonated oils, alkylsulphonic acid salts, alkylether sulphonic acid salts, alkylallylethersulphonic acid salts, alkylamidesulphonic acid salts, alkylphosphoric acid salts, alkyletherphosphoric acid salts, alkylallyletherphosphoric acid salts, alkyl and alkylallylpolyoxy-ethylene ethers, alkylallylformaldehyde condensed acid salts, alkylallylethersulphonic acid salts, alkylamidesulphonic acid salts, alkylphosphoric acid salts, alkyletherphosphoric acid salts, alkylallylether phosphoric acid salts, alkyl and alkylallylpolyoxy-ethylene ethers, alkylallylformaldehyde condensed polyoxyethylene ethers, blocked polymers having polyoxypropylene, polyoxyethylene polyoxypropylalkylethers, polyoxyethylene ether of glycolesters, polyoxyethylene ether of sorbitanesters, polyoxyethyleneether of sorbitolesters, polyethyleneglycol aliphatic acid esters, glycerol esters, sorbitane esters, propyleneglycol esters, sugar esters, fluoro C₂-C₁₀ alkylcarboxylic acids, disodium N-perfluorooctanesulphonyl glutamate, sodium 3-(fluoro-C₆-C₁₁-alkyloxy)-1-C₃-C₄ alkyl sulphonates, sodium 3-((-fluoro-C₆-C₈-alkanoyl-N-ethylamino)-1-propane sulfonates, N-[3-(perfluorooctanesulfonamide)-propyl]-N,N-dimethyl-N-carboxymethylene ammonium betaine, fluoro-C₁₁-C₂₀ alkylcarboxylic acids, perfluoro-C₇-C₁₃-alkyl-carboxylic acids, perfluorooctane sulphonic acid diethanolamide, Li, K and Na perfluoro-C₄-C₁₂-alkyl sulphonates, N-propyl-N-(2-hydroxyethyl)per-fluorooctane sulphonamide, perfluoro-C₆-C₁₀-alkylsulphonamide-propyl-sulphonyl-glycinates, bis-(N-perfluorooctylsulphonyl-N-ethanolamino-ethyl)phosphonate, mono-perfluoro C₆-C₁₆ alkyl-ethyl phosphonates, and perfluoroalkylbetaine.

Useful cationic surfactants include N-alkyl dimethyl ammonium chloride, palmityl trimethyl ammonium chloride, dodecyldimethylamine, tetradecyldimethylamine, ethoxylated alkyl guanidine-amine complex, oleamine hydroxypropyl bistrimonium chloride, oleyl imidazoline, stearyl imidazoline, cocamine acetate, palmitamine, dihydroxyethylcocamine, cocotrimonium chloride, alkyl polyglycolether ammonium sulphate, ethoxylated oleamine, lauryl pyridinium chloride, N-oleyl-1,3-diaminopropane, stearamidopropyl dimethylamine lactate, coconut fatty amide, oleyl hydroxyethyl imidazoline, isostearyl ethylimidonium ethosulphate, lauramidopropyl PEG-diamoniumchloride phosphate, palmityl trimethylammonium chloride, and cetyltrimethylammonium bromide.

Especially useful surfactants are the fluorocarbon surfactants having a structure of: F(CF₂)₄₋₉CH₂CH₂SCH₂CH₂N⁺R₃X⁻ wherein R is a hydrogen or an alkyl group as described in e.g. U.S. Pat. No. 4,781,985; and having a structure of: CF₃(CF₂)ₘCH₂CH₂O(CH₂CH₂O)ₙR wherein m=2 to 10; n=1 to 18; R is hydrogen or an alkyl group of 1 to 10 carbon atoms as described in U.S. Pat. No. 5,084,340. These surfactants are commercially available from DuPont and 3M. The concentration of the surfactant component in the receiving layer is typically in the range of 0.1 to 2%, preferably in the range of 0.4 to 1.5% and is most preferably 0.75% by weight based on the total dry weight of the layer.

### Ingredients to Improve Lightfastness of a Printed Image

According to a tenth embodiment of the receiving layer configuration, according to the present invention, the receiving layer configuration further comprises an ingredient to improve the lightfastness of an image applied to the image receiving-side of the receiving layer configuration.

According to a fourth embodiment of the information carrier precursor, according to the present invention, the receiving layer configuration and optional supplementary layers comprise at least one ingredient to improve the lightfastness of an image applied to the image-receiving side of the receiving layer configuration.

Examples of ingredients to improve the lightfastness of an image applied to the image-receiving side of the receiving layer configuration are antioxidants, UV-absorbers, peroxide scavengers, singlet oxygen quenchers such as hindered amine light stabilizers, (HALS compounds). Stilbene compounds are a preferred type of UV-absorber.

Luminescent fibres and/or luminescent beads Aspects of the present invention are realized by a receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer.

The luminescent beads may comprise 3 to 5 micron pigment particles chemically bound, which are inconspicuous in daylight but visible on inspection in darkened surroundings or after illumination at predetermined wavelength from an artificial source. The beads may for example be formed of a resin containing a light-reacting dye or of pre-formed light-reacting particles resin bonded, allowing close and pre-determined control of the particle size. Such pre-formed pigment particles are conveniently themselves of a resin containing a light reacting dye, but there is no restriction to these and for example pigment materials light reactive per se, such as phosphorescent zinc sulphide particles, may be bonded. The beads may be in various forms, e.g. aggregates of commercially available luminescent pigments used singly or to make mixed granules, or resins containing luminescent dye ground to form the granules, of granules of zinc or other phosphorescent compounds. It is also possible to use a combination of a resin, containing luminescent dye, acting as a binder for other pigments either in an aggregation process or in a direct process of formation of a block and grinding to size.

In the aspect of the invention where resin-dissolved fluorescent dyes are used, suitable dyes and resins are, for example, available from Swada (London) Ltd., Sugar House Lane, London E.15 in their “Fiesta” (Trade Mark) pigment range e.g. Fire Orange A 4 and Corona Magenta A 10. The fluorescence of organic dyes is associated with the individual molecules of the dyes, and in order for them to fluoresce efficiently they have to be molecularly dissolved in fairly low concentrations, for example from about 1 to 4%. As the dyes are organic in nature they have to be dissolved in an organic medium and in order to have a pigment it is essential for the medium to be solid. One type of material that meets these requirements is a melamine formaldehyde resin modified with sufficient aromatic sulphonamide to form a brittle thermoplastic or thermoset product which can be ground to the required particle size. Various red and orange shades are available with yellow, blue and green.

The aggregation process described above is necessary because commercial luminescent pigments are generally available only in standard particle sizes of perhaps 3 to 5 microns. The agglomeration process generates particles of the larger size suited to the present use. However, luminescent pigments such as the “Fiesta” range are in fact solutions of luminescent dyes in a base resin, and are made from block form by grinding. Where a single pigment is sufficient it can be made directly in the required size.

According to an eleventh embodiment of the receiving layer configuration, according to the present invention, the luminescent beads are formed of a resin containing a light-reacting dye.

According to a twelfth embodiment of the receiving layer configuration, according to the present invention, the luminescent beads are formed of pre-formed resin bonded light-reacting particles.

The luminescent material may be either fluorescent of phosphorescent. For example the porous receiving layer produced may be intended to be observed under U.V. light, the beads fluorescing in one or more colours. Each individual particle may show a single colour or a composite of two or more different colours.

According to a thirteenth embodiment of the porous receiving layer configuration, according to the present invention, the luminescent material is a Stokes type phosphor e.g. as described in U.S. Pat. No. 4,387,112. Such phosphors can be used as the luminescent substance in polymer beads. Such a phosphor has the property that it is excited by light energy at one length and phosphoresces at a different wavelength in releasing the excitation energy This has the beneficial characteristic in connection with authentification that, if one tries to detect an authentification marking by illuminating the phosphor in the visible, ultraviolet or infrared spectrum and looks for reflections or emissions in the same spectrum, no such reflections or emissions will be found and the phosphor will go undetected. Excitation and emission are both in narrow bands. Two or more of these phosphors can be employed to further complicate the authentification code. Examples of such pigments are Y₂O₂S:Er,Yb; and Gd_{(1-x-y)}YbₓTm_{z})₂O₂S and (Gd_{(1-x-y)})₂O₂S:YbₓTm_{z}, where x and y are numbers greater than 0, Yb is the ion capable of absorption and Tm is the ion capable of emission. Further examples are Lumilux Green CD 140 and IR-CD 139 [YVO₄:Nd] from Honeywell Specialty Chemicals, Seelze, GmbH and the luminescent pigment LLZ, Z, K, S, ZH and/or GE (available from Stardust Material, New York, N.Y. The illuminated color varies depending upon the type of pigment utilized. The Spectra MicroDiscrete longwave UV fluorescent pigments are also suitable:

| | | Chemical resistance | | |
|---|---|---|---|---|
| Fluorescent Color | Catalog# | solvent | bleach | caustic |
| Blue | MDP-1100- | good | good | good |
| BlueGreen | MDP-1200- | good | good | good |
| Green | MDP-1300- | good | good | good |
| YellowGreen | MDP-1400- | good | good | good |
| Yellow | MDP-1600- | | | |
| Orange | MDP-1700- | | | |
| Red | MDP-1800- | | | |
| BlueViolet | MDP-1900- | | | |

The Spectra PolyStar™ long UV fluorescent security particles from Spectra Systems Corporation, which are brightly fluorescent under UV light, are also suitable:

| | | Chemical resistance | | |
|---|---|---|---|---|
| Fluorescent Color | Catalog# | solvent | bleach | caustic |
| Blue | PSP-1100- | good | good | good |
| BlueGreen | PSP-1200- | good | good | good |
| Green | PSP-1300- | good | good | good |
| YellowGreen | PSP-1400- | good | good | good |
| Yellow | PSP-1600- | good | good | good |
| Orange | PSP-1700- | good | good | good |
| Red | PSP-1800- | good | good | good |
| BlueViolet | PSP-1900- | good | good | good |

as are the SpectraFluor fluorescent pigments also from Spectra Systems Corporation:

| | | | Peak | | Light- | | | |
|---|---|---|---|---|---|---|---|---|
| | | | Emission | | fastness | | | |
| | | | Wave- | | (Euro | | | |
| Fluorescent | Catalog | Excitation | length | | Blue | Chem Resistance | | |
| Color | # | Range | (nm) | Chemistry | Wool) | solvent | bleach | caustic |
| Red | SFP-0008 | Short UV | | Hybrid | | good | poor | good |
| White | SFP-0010 | Short UV | | Inorganic | | good | good | fair |
| Green | SFP-0013 | Short UV | | Inorganic | | good | good | fair |
| Red | SFP-0018 | Short UV | | Inorganic | | good | good | fair |
| Blue | SFP-1100 | Long UV | 486 | Organic | >L3 | good | good | good |
| BlueGreen | SFP-1200 | Long UV | 490 | Organic | <L2 | poor | fair | fair |
| Green | SFP-1300 | Long UV | 510 | Organic | L5 | good | good | good |
| YellowGreen | SFP-1400 | Long UV | 530 | Organic | L5 | good | good | good |
| Yellow | SFP-1600 | Long UV | 550 | Organic | L5 | good | good | good |
| Orange | SFP-1700 | Long UV | 550/615 | Organic/ | >L3 | good | poor | good |
| | | | | Hybrid | | | | |
| Red | SFP-1800 | Long UV | 615 | Hybrid | <L2 | good | poor | good |
| BlueViolet | SFP-1900 | Long UV | 415 | Organic | >L3 | fair | good | fair |
| Green | SFP-2300 | Long UV | 500 | Organic | >L4 | good | good | good |
| Blue | SFP-2100 | Long UV | 475 | Organic | >L4 | good | good | good |
| Red | SFP-2800 | Long UV | 613 | Inorganic | >L3 | good | good | fair |
| Blue | SFP-3100 | Long UV | 480 | Organic | L5 | good | good | good |

Further luminescent pigments suitable for dispersion in polymer beads are: copper-activated zinc sulphide and the Lumilux® range from Honeywell Specialty Chemicals, Seelze, GmbH supply e.g. Lumilux® effect blue SN-F, Lumilux® effect blue SN, Lumilux® effect red N 40, Lumilux® effect red N 100, Lumilux® effect sipi red, Lumilux® effect sipi yellow, Lumilux® effect green N-3F, Lumilux® effect green N-FF, Lumilux® effect-MB green, Lumilux® Green-F25, Lumilux® green SN-F2, Lumilux® green SN-F2Y, Lumilux® green SN-F5, Lumilux® green N 5, Lumilux® green N-PM, Lumilux® green N2, Lumilux® effect-MB green 1, Lumilux® MB green SN, Lumilux® effect green N-CO, Lumilux® effect green N-FG, Lumilux® effect green N-F, Lumilux® effect green N-E, Lumilux® effect green N-L and Lumilux® effect green N.

Further suitable luminescent pigments are finely-ground thermoset plastic resins containing a selected fluorescent dye [such as one of the rhodamines] cross-linked into the matrix e.g. a phthalate ester plasticizer carrier with a formula of 40 g/100 mL of fluorescent pigment/phthalate plasticizer being preferred.

The Day-Glo® invisible security products with UV-excitation can also be used e.g. Invisible Yellow D-034 (emission wavelength 507 nm), Invisible Red IPO-13 (emission wavelength 620 nm), Invisible Orange IPO-15 (emission wavelength 590 nm), Invisible Green IPO-18 (emission wavelength 530 nm) and Invisible Blue IPO-19 (emission wavelength 450 nm).

Microtrace microtaggant encoded particles can also be used e.g. providing IR-visible phosphors with emission in green, red, blue and orange.

Luminescent fibres can be produced by compounding a luminescent substance with a selected polymer resin and then extruding the resulting mixture. Alternatively luminescent fibres may be formed by wet spinning. A suitable concentration of luminescent substance is 2×10⁻³ M. The diameter of the fibres is selected in accordance with the selected emission wavelength. The treads may be comprised of fibres such as nylon-6, nylon 6/6, PET, ABS, SAN and PPS. By example a selected dye may be selected from Pyrromethene 567, Rhodamine 590 chloride, and Rhodamine 640 perchlorate. Upon incorporating laser dyes into plastic threads, glass fibres or other transparent fibres, in particular textile fibres, a laser resonator is advantageously formed. If a plastic thread having a finite length is provided with mirrors at both ends and excited with a laser, a resonance phenomenon is produced i.e. the plastic thread itself operates as a laser since the excitation light causes a stimulated emission along the fibre. As for platelets, the length of the fibre and the reflection at the fibre ends determines the peak position and the half width of the emission peak. It is actually not necessary to provide the end faces with mirrors, and end faces without mirrors are sufficient. In the latter case, however, the dye embedded in the plastic thread has to be sufficiently efficient. This result is not limited to plastic threads, and any other type of thread can be used. The invention is based on the general principle discussed above, i.e., embedding such laser-excitable dyes in the securities and secure documents, with the goal to produce an optical resonance resulting in sharp, narrow-band peaks.

### Pigments

According to a fourteenth embodiment of the receiving layer configuration, according to the present invention, the pigment is an inorganic pigment. Any inorganic pigment well-known in the art may be used.

According to a fifteenth embodiment of the receiving layer configuration, according to the present invention, the pigment is an inorganic pigment selected from the group consisting of silica, talc, clay, hydrotalcite, kaolin, diatomaceous earth, calcium carbonate, magnesium carbonate, basic magnesium carbonate, aluminosilicate, aluminium trihydroxide, aluminium oxide (alumina), titanium oxide, zinc oxide, barium sulphate, calcium sulphate, zinc sulphide, satin white, boehmite (alumina hydrate), zirconium oxide or mixed oxides.

According to a sixteenth embodiment of the receiving layer configuration, according to the present invention, the pigment is an inorganic pigment selected from the group consisting of silica, aluminosilicate, alumina, calcium carbonate, alumina hydrate, and aluminium trihydroxide.

According to a seventeenth embodiment of the receiving layer configuration, according to the present invention, the pigment is silica.

According to a fifth embodiment of the information carrier precursor, according to the present invention, the pigment is an inorganic pigment.

According to a sixth embodiment of the information carrier precursor, according to the present invention, the pigment is silica.

Refractive indices of suitable pigments are given in the table below:

| | refractive index for |
|---|---|
| inorganic opacifying pigment | sodium line at 589.3 nm |
| silica - silica gel | 1.55 |
| SIPERNAT ® 570 | 1.45 to 1.47 |
| kaolinite | 1.53-1.57 |
| bentonite | 1.557 |
| china clay | 1.56 |
| porous alumina pigment | 1.6 |
| e.g. MARTINOX GL-1 | |

The use of aluminium oxide (alumina) in receiving layers is disclosed in several patents, e.g. in U.S. Pat. No. 5,041,328, U.S. Pat. No. 5,182,175, U.S. Pat. No. 5,266,383, EP 218956, EP 835762 and EP 972650.

Commercially available types of aluminium oxide (alumina) include α-Al₂O₃ types, such as NORTON E700, available from Saint-Gobain Ceramics & Plastics, Inc, γ-Al₂O₃ types, such as ALUMINUM OXID C from Degussa, Other Aluminium oxide grades, such as BAIKALOX CR15 and CR30 from Baikowski Chemie; DURALOX grades and MEDIALOX grades from Baikowski Chemie, BAIKALOX CR80, CR140, CR125, B105CR from Baikowski Chemie; CAB-O-SPERSE PG003 trademark from Cabot, CATALOX GRADES and CATAPAL GRADES from Sasol, such as PLURALOX HP14/150; colloidal Al₂O₃ types, such as ALUMINASOL 100; ALUMINASOL 200, ALUMINASOL 220, ALUMINASOL 300, and ALUMINASOL 520 trademarks from Nissan Chemical Industries or NALCO 8676 trademark from ONDEO Nalco.

A useful type of alumina hydrate is γ-AlO(OH), also called boehmite, such as, in powder form, DISPERAL, DISPERAL HP14 and DISPERAL 40 from SASOL, MARTOXIN VPP2000-2 and GL-3 from Martinswerk GmbH.; Liguid boehmite alumina systems, e.g. DISPAL 23N4-20, DISPAL 14N-25, DISPERAL AL25 from SASOL. Patents on alumina hydrates include EP 500021, EP 634286, U.S. Pat. No. 5,624,428, EP 742108, U.S. Pat. No. 6,238,047, EP 622244, EP 810101, etc.

Useful aluminium trihydroxides include Bayerite, or α-Al(OH)₃, such as PLURAL BT, available from SASOL, and Gibbsite, or γ-Al(OH)₃, such as MARTINAL grades from Martinswerk GmbH, MARTIFIN grades, such as MARTIFIN OL104, MARTIFIN OL 107 and MARTIFIN OL111 from Martinswerk GmbH , MICRAL grades, such as MICRAL 1440, MICRAL 1500; MICRAL 632; MICRAL 855; MICRAL 916; MICRAL 932; MICRAL 932CM; MICRAL 9400 from JM Huber company; HIGILITE grades, e.g. HIGILITE H42 or HIGILITE H43M from Showa Denka K.K., HYDRAL GRADES such as HYDRAL COAT 2, HYDRAL COAT 5 and HYDRAL COAT 7, HYDRAL 710 and HYDRAL PGA, from Alcoa Industrial Chemicals.

A useful type of zirconium oxide is NALCO OOSS008 trademark of ONDEO Nalco, acetate stabilized ZrO₂, ZR20/20, ZR50/20, ZR100/20 and ZRYS4 trademarks from Nyacol Nano Technologies. Useful mixed oxides are SIRAL grades from SASOL, colloidal metal oxides from Nalco such as Nalco 1056, Nalco TX10496, Nalco TX11678.

Silica as pigment in receiving elements is disclosed in numerous old and recent patents, e.g. U.S. Pat. No. 4,892,591, U.S. Pat. No. 4,902,568, EP 373573, EP 423829, EP 487350, EP 493100, EP 514633, etc. Different types of silica may be used, such as crystalline silica, amorphous silica, precipitated silica, gel silica, fumed silica, spherical and non-spherical silica, calcium carbonate compounded silica such as disclosed in U.S. Pat. No. 5,281,467, and silica with internal porosity such as disclosed in WO 00/02734. The use of calcium carbonate in receiving layers is described in e.g. DE 2925769 and U.S. Pat. No. 5,185,213. The use of alumino-silicate is disclosed in e.g. DE 2925769. Mixtures of different pigments may be used.

In an alternative embodiment the main pigment can be chosen from organic particles such as polystyrene, polymethyl methacrylate, silicones, melamine-formaldehyde condensation polymers, urea-formaldehyde condensation polymers, polyesters and polyamides. Mixtures of inorganic and organic pigments can be used. However, most preferably the pigment is an inorganic pigment. The pigment must be present in a sufficient coverage in order to render the receiving layer sufficiently opaque and porous. The lower limit of the ratio by weight of the binder to the total pigment in the receiving layer is preferably about 1:50, most preferably 1:20, while the upper limit thereof is about 2:1, most preferably 1:1. If the amount of the pigment exceeds the upper limit, the strength of the receiving layer itself is lowered, and the resulting image hence tends to deteriorate in rub-off resistance and the like. On the other hand, if the binder to pigment ratio is too great, the ink-absorbing capacity of the resulting receiving layer is reduced, and so the image formed may possibly be deteriorated.

The transparentization process is dependent upon the refraction indices of the pigment on the one hand, and of the lacquer which penetrates the receiving layer (see description below) on the other hand should match each other as closely as possible. The closer the match of the refraction indices, the better the transparency which will be obtained after impregnation of the receiver layer with the lacquer.

The most preferred pigment is a silica type, more particularly an amorphous silica having a average particle size ranging from 1 μm to 15 μm, most preferably from 2 to 10 μm. A most useful commercial compound is the amorphous precipitated silica type SIPERNAT 570, trade name from Degussa Co. It is preferably present in the receiving layer in an amount ranging from 5 g/m² to 30 g/m². It has the following properties:

specific surface area (N₂ absorption): 750 m²/g

mean particle size (Multisizer, 100 μm capillarity): 6.7 μm

DBP [DiButyl Phthalate] adsorption: 175-320 g/100 g

refractive index: 1.45 à 1.47.

Since the refractive index of a typical UV-curable lacquer composition is about 1.47 à 1.49 it is clear that there is good match with the refractive index of this particular silica type, and good transparency will be obtained.

Other usable precipitated silica types include SIPERNAT 310, 350 and 500, AEROSIL grades (trade mark of Degussa-Hüls AG), and SYLOID types (trade mark from Grace Co.).

A receiving layer containing a porous alumina pigment such as MARTINOX GL-1 does not become completely transparent upon impregnation with acrylate/methacrylate-based lacquers with a refractive index of 1.47 to 1.49 because its refractive index is 1.6. However, lacquers with higher refractive indexes are possible e.g. including N-vinyl carbazole as comonomer.

The adhesion of receiving layers impregnated with a lacquer according to the method for producing an information carrier, according to the present invention, to the rigid sheet or support undergoes a strong improvement upon subsequent curing e.g. UV-hardening.

### Receiving Layer Binder

According to an eighteenth embodiment of the receiving layer configuration, according to the present invention, the binder is a water-soluble binder, a solvent-soluble binder or a latex.

According to a nineteenth embodiment of the receiving layer configuration, according to the present invention, the receiving layer configuration comprises at least one latex in at least one constituent layer.

According to a seventh embodiment of the information carrier precursor, according to the present invention, the binder is a water-soluble binder, a solvent-soluble binder or a latex The binder can be chosen from a list of compounds well-known in the art including hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; polyvinyl alcohol; vinylalcohol copolymers; polyvinyl acetate; polyvinyl acetal; polyvinyl pyrrolidone; polyacrylamide; acrylamide/acrylic acid copolymer; polystyrene, styrene copolymers; acrylic or methacrylic polymers; styrene/acrylic copolymers; ethylene-vinylacetate copolymer; vinylmethyl ether/maleic acid copolymer; poly(2-acrylamido-2-methyl propane sulfonic acid); poly(diethylene triamine-co-adipic acid); polyvinyl pyridine; polyvinyl imidazole; polyethylene imine epichlorohydrin modified; polyethylene imine ethoxylated; polyethylene oxide; polyurethane; melamine resins; gelatin; carrageenan; dextran; gum arabic; casein; pectin; albumin; starch; collagen derivatives; collodion and agar-agar.

A preferred binder for the practice of the present invention is a polyvinylalcohol (PVA), a vinylalcohol copolymer or modified polyvinyl alcohol. Most preferably, the polyvinyl alcohol is a silanol modified polyvinyl alcohol. Most useful commercially available silanol modified polyvinyl alcohols can be found in the POVAL R polymer series, trade name of Kuraray Co., Japan. This R polymer series includes the grades R-1130, R-2105, R-2130, R-3109, which differ mainly in the viscosity of their respective aqueous solutions. The silanol groups are reactive to inorganic substances such as silica or alumina. R-polymers can be easily crosslinked by changing the pH of their aqueous solutions or by mixing with organic substances and can form water resistant films.

Upon varying the pigment/latex ratio between 2 and 6.5 (2, 2.2, 2.45, 2.70, 2.75, 3.5, 3.78, 4.25, 5 and 6.25) in a constituent layer with SYLOID® W-300 as pigment it was found that the amount of ink bleeding decreased with increasing pigment/latex ratio. At too high ratios of pigment/latex the receiving layer becomes too powdery. With SYLOID® W-300 the best image sharpness was observed at a weight ratio of total pigment to total latex of 3.29. Furthermore, the presence of very high latex concentrations prohibitively reduces the rub-resistance of the printed image.

According to a twentieth embodiment of the receiving layer configuration, according to the present invention, at least one constituent layer of said receiving layer configuration comprises at least one pigment and at least one latex and the weight ratio of total pigment to total latex in said constituent layer is in the range of 3 to 6.5.

As the latex concentration in the outermost receiving layer in the receiving layer configuration increases ink-jet images printed on the outermost receiving layer bleeding of the ink-jet ink increases and as a result the raster of the ink-jet image is lost in favour of continuous tone imaging. Alternatively as the latex concentration in the outermost receiving layer decreases ink-jet images on the outermost receiving layer become sharper and sharper. The best image quality was found with a total pigment to total latex of 3.29:1 in the case of SYLOID® W-300 as pigment.

### Rigid Sheet or Support

According to an eighth embodiment of the information carrier precursor, according to the present invention, the rigid sheet or support comprises at least one layer and/or a multilayed laminate or co-extrudate. Examples of suitable co-extrudates are PET/PETG and PET/polycarbonate.

The support can be a sheet or web support.

According to a ninth embodiment of the information carrier precursor, according to the present invention, the support is a web support.

According to a tenth embodiment of the information carrier precursor, according to the present invention, the rigid sheet or support has been preprinted with a security print.

The support for use in the present invention can be transparent, translucent or opaque, and can be chosen from paper type and polymeric type supports well-known from photographic technology. Paper types include plain paper, cast coated paper, polyethylene coated paper and polypropylene coated paper. Polymeric supports include cellulose acetate propionate or cellulose acetate butyrate, polyesters such as polyethylene terephthalate and polyethylene naphthalate, polyamides, polycarbonates, polyimides, polyolefins, poly(vinylacetals), polyethers and polysulfonamides. Other examples of useful high-quality polymeric supports for the present invention include opaque white polyesters and extrusion blends of polyethylene terephthalate and polypropylene. Polyester film supports and especially polyethylene terephthalate are preferred because of their excellent properties of dimensional stability. When such a polyester is used as the support material, a subbing layer may be employed to improve the bonding of the receiving layer to the support. Useful subbing layers for this purpose are well known in the photographic art and include, for example, polymers of vinylidene chloride such as vinylidene chloride/acrylonitrile/acrylic acid terpolymers or vinylidene chloride/methyl acrylate/itaconic acid terpolymers.

In a most preferred embodiment of the present invention the support is coloured or whitened polyvinyl chloride, polyethylene terephthalate or polycarbonate.

### Method for Producing an Information Carrier

Aspects of the present invention are realized by a method for producing an information carrier comprising the steps of: providing an information carrier precursor comprising a rigid sheet or a support and a receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer; and printing an image or pattern on the porous receiving layer of the information carrier precursor by a conventional printing process using at least one liquid printing ink.

According to a first embodiment of the method for producing an information carrier, according to the present invention, the process further comprises the step of applying said transparentizing lacquer to at least part of the areas of said outermost surface of said receiving layer configuration which are opaque and porous thereby transparentizing at least in part the areas of said receiving layer configuration which are opaque and porous to which said transparentizing lacquer has been applied; and optionally curing said transparentizing lacquer.

According to a second embodiment of the method for producing an information carrier, according to the present invention, the process further comprises the steps of applying said transparentizing lacquer to at least part of the areas of said outermost surface of said receiving layer configuration which are opaque thereby transparentizing at least in part the areas of said receiving layer configuration which are opaque and porous to which said transparentizing lacquer has been applied; optionally curing said transparentizing lacquer; and applying an image or pattern to the outermost layer of said receiving layer configuration using a conventional printing process, preferably ink-jet printing

According to a third embodiment of the method for producing an information carrier, according to the present invention, the process further comprises the steps of applying said transparentizing lacquer to at least part of the areas of said outermost surface of said receiving layer configuration which are opaque and porous thereby transparentizing at least in part the areas of said receiving layer configuration which are opaque and porous to which said transparentizing lacquer has been applied; optionally curing said transparentizing lacquer; and applying an image or pattern to said opaque and porous parts of the outermost layer of said receiving layer configuration using a conventional printing process, preferably ink-jet printing.

Apparatuses for UV-curing are known to those skilled in the art and are commercially available. For example, the curing proceeds with medium pressure mercury vapour lamps with or without electrodes, or pulsed xenon lamps. These ultraviolet sources usually are equipped with a cooling installation, an installation to remove the produced ozone and optionally a nitrogen inflow to exclude air from the surface of the product to be cured during radiation processing. An intensity of 40 to 240 W/cm in the 200-400 nm region is usually employed. An example of a commercially available UV-curing unit is the DRSE-120 conveyor from Fusion UV Systems Ltd., UK with a VPS/1600 UV lamp, an ultraviolet medium-pressure electrodeless mercury vapour lamp. The DRSE-120 conveyor can operate at different transport speeds and different UV power settings over a width of 20 cm and a length in the transport direction of 0.8 cm. Moreover, it can also be used with metal halide-doped Hg vapour or XeCl excimer lamps, each with its specific UV emission spectrum. This permits a higher degree of freedom in formulating the curing composition: a more efficient curing is possible using the lamp with the most appropriate spectral characteristics. A pulsed xenon flash lamp is commercially available from IST Strahlentechnik GmbH, Nürtingen, Germany.

According to a fourth embodiment of the method for producing an information carrier, according to the present invention, the method further comprises the step of applying a digitally stored set of information to the outermost surface of the receiving layer configuration using a conventional printing process e.g. using ink-jet printing, electrophotographic printing, electrographic printing or thermal transfer printing. In a most preferred embodiment this digitally stored information is personalized information different for each individual item present on the information carrier. For instance, this personalized information may be a unique individual card number assigned to the future bearer of the card, or the expiry date of the validity of the card, or personal data of the future bearer, e.g. a birth day, and/or a photo. Again, when the information carrier is meant to be cut in multiple ID cards, the ink jet printing step is repeated over multiple areas of the support in register with the security print pattern when present, thereby providing each item with different personalized information.

According to a fifth embodiment of the method for producing an information carrier, according to the present invention, an embossable layer is applied to the outermost surface of the receiving layer configuration and the embossable layer is then embossed.

According to a sixth embodiment of the method for producing an information carrier, according to the present invention, a black image is printed on the outermost surface of the receiving layer configuration and the black image develops a relief pattern upon UV-hardening.

According to a seventh embodiment of the method for producing an information carrier, according to the present invention, a metal fibre or strip is applied in a hardenable composition to the outermost surface of the receiving layer configuration.

According to an eighth embodiment of the method for producing an information carrier, according to the present invention, the method further comprises the step of applying an image or pattern to the outermost layer of said receiving layer configuration using a conventional printing process, the printing process being preferably ink-jet printing.

According to a ninth embodiment of the method for producing an information carrier, according to the present invention, the method further comprises the step of applying an image or pattern to the opaque parts of the outermost layer of the receiving layer configuration using a conventional printing process, the printing process being preferably ink-jet printing.

When the information carrier is meant to be cut later on into multiple identity cards the security print is repeatedly applied over multiple areas of the web or sheet by a step and repeat process thus giving rise to multiple identical items. These multiple identical items are distributed over the support according to a fixed pattern, e.g. a rectangular grid. Furthermore, the application and curing of the varnish is repeated over multiple areas of the information carrier (in register) with the multiple different items already present consisting of optional security print and personalized information.

An opaque background can be realised by selecting a lacquer capable of penetrating into the receiving layer configuration, but with a refractive index that differs too much from the refractive index of the pigment, so that it is not capable to render the receiving layer configuration transparent.

Another way to keep the background opaque is by curing the lacquer composition before it can substantially penetrate into the receiving layer configuration. The penetration behaviour of varnish and lacquer are reversed compared to the first embodiment. This behaviour again is controlled by the viscosity and/or the penetration time.

### Ink-Jet Printing

If ink jet printing is used, in the method for producing an information carrier, according to the present invention, it may be performed by any known technique known in the art. In a first type of process a continuous droplet stream is created by applying a pressure wave pattern. This process is known as continuous ink jet printing. In a first embodiment the droplet stream is divided into droplets that are electrostatically charged, deflected and recovered, and into droplets that remain uncharged, continue their way undeflected, and form the image. Alternatively, the charged deflected stream forms the image and the uncharged undeflected jet is recollected. In this variant of continuous ink jet printing several jets are deflected to a different degree and thus record the image (multideflection system).

According to a second ink-jet process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

Ink compositions for ink jet typically include following ingredients: dyes or pigments, water and/or organic solvents, humectants such as glycols, detergents, thickeners, polymeric binders, preservatives, etc. It will be readily understood that the optimal composition of such an ink is dependent on the ink jetting method used and on the nature of the substrate to be printed. The ink compositions can be roughly divided into:

water based: the drying mechanism involves absorption, penetration and evaporation;

oil based: drying involves absorption and penetration;

solvent based: drying mechanism involves primarily evaporation;

hot melt or phase change: the ink vehicle is liquid at the ejection temperature but solid at room temperature i.e. drying is replaced by solidification;

UV-curable: drying is replaced by photopolymerization.

### The colorants present in the ink jet ink may be dyes which are molecularly dissolved in the ink fluid, e.g. acid dyes which are bound by a cationic mordant in the ink receiver, or they may be pigments which are finely dispersed in the ink fluid.

### Transparentizing Lacquer Compositions

The term “lacquer”, as used in disclosing the present invention, means a liquid under the application conditions, which is transparent, comprises at least one polymer and/or at least one wax and can solidify upon cooling, become solid upon evaporation of solvent or harden/cross-link upon exposure to heat, moisture or radiation e.g. visible light, UV-radiation and electron beams i.e. is curable.

The substantial penetration of the receiving layer configuration by the lacquer can be realized by controlling the penetration time and/or the viscosity of the composition. The viscosity of the transparentizing lacquer composition is adjusted to ensure rapid penetration and hence rapid transparentization.

According to a tenth embodiment of the method for producing an information carrier, according to the present invention, the lacquer is a curable lacquer e.g. thermally curable, electron beam curable or photopolymerizable.

According to an eleventh embodiment of the method for producing an information carrier, according to the present invention, the lacquer is a radiation curable lacquer.

According to a twelfth embodiment of the method for producing an information carrier, according to the present invention, the lacquer is a photopolymerizable lacquer.

Transparentization process depends upon the refraction indices of the pigment and of the lacquer which penetrates the receiving layer configuration matching each other as closely as possible. The closer the match of the refraction indices, the better the transparency which will be obtained after impregnation of the receiver layer with the lacquer. Therefore, the choice of ingredients for the lacquer has to be such as to fulfill this requirement. Additional constraints on the composition of the lacquer are determined by whether the lacquer is required to be curable and if curable which curing process has been selected.

According to a thirteenth embodiment of the method for producing an information carrier, according to the present invention, the refractive index of the pigment and the refractive index of the transparentizing lacquer differ by no more than 0.1.

According to a fourteenth embodiment of the method for producing an information carrier, according to the present invention, the refractive index of the pigment and the refractive index of the transparentizing lacquer differ by no more than 0.04.

According to a fifteenth embodiment of the method for producing an information carrier, according to the present invention, the refractive index of the pigment and the refractive index of the transparentizing lacquer differ by no more than 0.02.

Refractive indices of representative polymers are given below:

| | Refractive index for sodium |
|---|---|
| | line at 589.3 nm [ASTM D642] |
| polystyrene | 1.57-1.60 |
| poly-α-methyl-styrene | 1.610 |
| poly-4-methyl-styrene | — |
| poly-α-vinyl-naphthalene | 1.6818 |
| polyacrylonitrile | 1.514, 1.5187 |
| polymethacrylonitrile | 1.520 |
| polymethyl methacrylate | 1.49, 1.4893 |
| polyacrylamide | — |
| copolymer of acrylonitrile and styrene | 1.56-1.57, 1.57 |
| copolymer of 28.5 wt % acrylonitrile | 1.56-1.57, 1.57 |
| and 71.5 wt % styrene | |

An essential ingredient of a curable lacquer is at least one monomer. In the case of the curable lacquer being a photopolymerizable lacquer the lacquer will further contain at least one photoinitiator.

The refractive index of curable lacquers based on acrylates and methacrylates are there typically 1.47 to 1.49 and hence the use of such compositions as lacquers, according to the present invention, will provide a good match with the refractive index of SIPERNAT 570 with a refractive index of 1.45 to 1.47, and hence good transparency is obtained.

Suitable monomers for use in curable lacquers include the monomers disclosed in DE-OS 4005231, DE-OS 3516256, DE-OS 3516257, DE-OS 3632657 and U.S. Pat. No. 4,629,676, unsaturated esters of polyols, particularly such esters of the α-methylene carboxylic acids, e.g. ethylene diacrylate, glycerol tri(meth)acrylate, diethylene glycol di(meth)acrylate, 1,3-propanediol di(meth)acrylate, 1,2,4-butanetriol tri(meth)acrylate, 1,4-cyclohexanediol di(meth)acrylate, 1,4-benzenediol di(meth)acrylate, pentaerythritol tetra(meth)-acrylate, pentaerythritol triacrylate, dipentaerythritol penta-acrylate, trimethylolpropane triacrylate, 1,5-pentadiol di(meth)-acrylate, bis-acrylates and bis-methacrylates of polyethylene glycols of molecular weight 200-500; unsaturated amides, particularly those of the α-methylene carboxylic acids, and especially those of α,ω-diamines and oxygen-interrupted ω-diamines, such as bis-acrylamide, methylene bis-methacrylamide, 1,6-hexa-methylene bis-acrylamide, diethylene triamine tris-methacrylamide, bis(γ-methacrylamidopropoxy)ethane, β-methacryl-amidoethyl methacrylate, N-(β-hydroxyethyl)-β-(methacrylamido)ethyl acrylate, and N,N-bis(β-methacryloyl-oxyethyl)acrylamide; vinyl esters, e.g. divinyl succinate, divinyl adipate, divinyl phthalate, divinyl butane-1,4-disulphonate; and unsaturated aldehydes, e.g. sorbaldehyde (hexadienal).

Curable lacquers may also comprise polymers and/or oligomers comprising two or more different polymerizable functions, e.g. acrylated epoxies, polyester acrylates, urethane acrylates, etc.

It is also possible to use monofunctional (meth)acrylic acid esters as monomer provided they are not to volatile and do not spread an unwanted odour. Suitable compounds include n-octyl-acrylate, decylacrylate, decylmethacrylate, stearylacrylate, stearylmethacrylate, cyclohexylacrylate, cyclohexylmethacrylate, phenylethylacrylate, phenylethylmethacrylate. The most preferred compounds comprise one or more (meth)acrylate functional groups.

Preferred monomers for use in UV-curable photopolymerizable compositions have at least one (meth)acrylate functional group, such as those disclosed in EP-A 0 502 562.

Monomer/oligomers including commercially available compounds (chemical and commercial names) suitable for use in the transparentizing curable compositions used in the method for producing an information carrier, according to the present invention, include: pentaerythritol triacrylate (SR-444 from Sartomer), trimethylolpropane triacrylate (SR-351 from Sartomer); dipropyleneglycol diacrylate (SR-508 from Sartomer); amine-modified polyether acrylate oligomer (CN-501 from Sartomer); isobornyl acrylate (SR-506 from Sartomer); diethyleneglycol divinylether (RAPI-CURE DVE-2 from ISP); triethyleneglycol divinylether (RAPI-CURE DVE-3 from ISP); urethane acrylate blended with 2(2-ethoxy-ethoxy)ethylacrylate (SR-256 and CN-966H90 from Sartomer); polybutadiene dimethyl acrylate (CN-301 from Sartomer); low viscosity oligomer (CN-135 from Sartomer); and low viscosity oligomer (CN-137 from Sartomer).

A wide variety of photopolymerizable and photocrosslinkable compounds can be used in the present invention. Suitable photo-initiators include all compounds or compound combinations known for this purpose e.g. benzoin ethers, benzil ketals, polycyclic quinones, benzophenone derivatives, triarylimidazolyl dimers, photo-sensitive trihalomethyl compounds e.g. trichloromethyl-s-triazines. Preferred photoinitiators are the 2,3-bisarylquinoxalines, as disclosed in U.S. Pat. No. 3,765,898, and 2-aryl-4,6-bis-tri-chloromethyl-s-triazines. The amount of photoinitiator or photo-initiator combination is generally 1-25% by weight of the photopolymerizable composition and preferably between 5 and 15% by weight.

Suitable photoinitiators and thermal initiators including commercially available compounds (chemical and commercial names) suitable for use in the transparentizing curable compositions used in the method for producing an information carrier, according to the present invention, include the photoinitiators: IRGACURE 907 (from Ciba-Geigy Co.), NOVOPOL PI3000 (from Rahn Co.), GENOCURE DEAP (from Rahn Co.), IRGACURE 184 (from Ciba-Geigy Co.), EZACURE KK (from Fratelli Lamberti Co.), IRGACURE 500 (from Ciba-Geigy Co.) and IRGACURE 819 (from Ciba-Geigy Co.); and the thermal initiators: AIBN, dicumyl peroxide, benzoyl peroxide, t-butyl peroxide, VAZO compounds (from DuPont Co.) e.g. VAZO 52, LUPEROX (from Atofina Co.) e.g. 233, 10, 11, 231, 101, hydroperoxides and peresters.

Photopolymerizable lacquers may also contain a minor amount of a heat polymerization inhibitor which prevents premature polymerization before the UV curing step. Examples of such inhibitors include p-methoxyphenol, hydroquinone, aryl- or alkyl substituted hydroquinone, t-butylcatechol, pyrogallol, copper(I) chloride, phenothiazine, chloranil, naphthylamine, α-naphthol, 2,6-di-t-butyl-p-cresol, etc. A preferred polymerization inhibitor is 2-methyl hydroquinone. The heat polymerization inhibitors are preferable used in an amount of 0.001 to 5 parts by weight per 100 parts of monomer.

Curable lacquers may optionally contain a minor amount of organic solvent, e.g. ethyl acetate. Suitable solvents for use in the transparentizing curable compositions used in the method for producing an information carrier, according to the present invention, include the following commercially available compounds (chemical and commercial names).

According to a sixteenth embodiment of the method for producing an information carrier, according to the present invention, the lacquer further contains at least one colorant e.g. a dye or a pigment.

### Information Carrier

According to a first embodiment of the information carrier, according to the present invention, the information carrier is an identification card selected from the group consisting of an identity card, a security card, a driver's license card, a social security card, a membership card, a time registration card, a bank card, a pay card and a credit card.

According to a second embodiment of the information carrier according to the present invention, the information carrier is provided with a printed pattern or image, with an offset-, screen-, flexo-, driographically or ink-jet printed pattern or image being preferred and an ink-jet printed pattern or image being particularly preferred.

According to a third embodiment of the information carrier according to the present invention, the image or pattern is printed by ink-jet printing and the resulting ink-jet image upon exposure to a non-visible light source is interrupted by luminescing luminescent fibres and/or luminescent beads and/or luminescent particles.

Most types of ID cards have now the standardized dimensions of 85.6 mm×54.0 mm×0.76 mm. This final thickness can be reached by thermal lamination of one or more polymeric foils, e.g. PVC foils. The finished ID card can serve as an identity card, a security card, a driver's license card, a social security card, a bank card, a membership card, a time registration card, a pay card and a credit card, etc.

Apart from the features described above the finished ID card may comprise additional security elements or information carriers such as a hologram, a magnetic strip, or a chip (“smart cards”).

According to a fourth embodiment of the information carrier according to the present invention, the information carrier is a flexible sheet e.g. any page of a passport or a page of a passport with personalized data of the bearer.

According to a fifth embodiment of the information carrier according to the present invention, the information carrier is an admission document e.g. a visa, a ticket for an event and lottery tickets.

According to a sixth embodiment of the information carrier according to the present invention, the information carrier is an identification card selected from the group consisting of an identity card, a security card, a driver's license card, a social security card, a membership card, a time registration card, a bank card, a pay card, a credit card and a passport page.

The present invention is illustrated hereinafter by way of COMPARATIVE EXAMPLES and INVENTION EXAMPLES without be limited thereto. The percentages and ratios given in these examples are by weight unless otherwise indicated.

### INVENTION EXAMPLE 1

A 100 μm thick sheet of transparent polyethylene terephthalate subbed with subbing layer 1 was coated with the porous receiver layer dispersion with the composition given in table 1:

TABLE 1

| | | |
|---|---|---|
| Syloid ™ W300, a colloidal silica from GRACE GMBH | 75.6 | g |
| Poval PVA R3109, a silanol modified polyvinyl alcohol from | 2.3 | g |
| KURARAY | | |
| Catfloc ™ T2, a cationic polyelectrolyte from | 5.6 | g |
| CALGON EUROPE | | |
| Bronidox ™ K, a biocide from HENKEL | 0.3 | g |
| (5% solution in ethanol) | | |
| Citric acid | 0.3 | g |
| Small quantity of cut green-fluorescing textile fibres | | |
| Polysol ™ EVA P-550, a 50% aqueous emulsion of an | 100 | g |
| ethylene-vinyl acetate-vinyl versatate copolymer from | | |
| SHOWA HIGH POLYMER CO. | | |
| Aerosol ™ OT, a surfactant from CYTEC | 1.5 | g |
| Tergitol ™ 4, a surfactant from UNION CARBIDE | 1 | g |
| Water to make | 1000 | g |

using a 100 μm wirebar followed by drying at 50° C. producing an opaque microporous layer with a layer thickness of 22 μm and an optical density of 0.19 measured with a MacBeth RB918-SB densitometer with a visible filter and with a black sheet of cardboard with a density of 1.35 placed under the transparent polyethylene terephthalate support.

The opaque microporous layer was then partially overcoated with the lacquer given in Table 2 below with a 50 μm wirebar. About two minutes after the application of the solution curing was performed by means of a DRSE-120 conveyor from Fusion UV Systems Ltd. with a VPS/1600 UV lamp (speed 20 m/min, 50% UV power setting giving over a width of 20 cm and a length in the transport direction of 0.8 cm: a UV-A intensity of 1.176 W/cm², a UVB intensity of 0.466 W/cm² and a UVC intensity of 0.067 W/cm²). To obtain a complete curing three passes were necessary.

The thereby transparentized areas of the porous layer had an optical density of 1.40 with a black sheet of cardboard with a density of 1.35 placed under the transparent polyethylene terephthalate support.

TABLE 3
Composition of UV curable transparent lacquer

| | | |
|---|---|---|
| Isobornylacrylate | 416.2 | g |
| Actilane ™ 411, a monofunctional acrylate diluent from | 247.7 | g |
| AKZO NOBEL | | |
| Ebecryl ™ 1039, an urethanemonoacrylate from | 178.4 | g |
| UCB CHEMICALS | | |
| Ebecryl ™ 11, a polyethylene glycol diacrylate from | 99.1 | g |
| UCB CHEMICALS | | |
| Irgacure ™ 500, a photo-initiator from CIBA-GEIGY | 49.6 | g |
| Perenol ™ S Konz (50% in ethyl acetate), a surfactant from | 9 | g |
| HENKEL | | |

The fluorescent cut fibres are visible in the non-transparentized area of the porous layer with irradiation at 366 nm with a UV-lamp due to the diameter of the fibres being greater than the dry layer thickness of the microporous layer. The fluorescent fibres are also not visible in the transparentized part of the porous layer due to the transparency of the fluorescent fibres. However, upon irradiating the lacquer-transparentized part of the porous layer with the UV-lamp the incorporated fluorescent fibres were clearly and sharply observable as a result of their green fluorescence and surprisingly broke up an ink-jet image printed on the outermost surface of the porous layer prior to the transparentization.

This demonstrates that incorporation of fluorescent fibres in transparentizable microporous layers can be used as a covert security feature in lacquer-transparentized porous layers, the fluorescent fibres being detectable as sharp well-defined images upon irradiation with UV-light, which break up an ink-jet image printed on the outermost surface of the porous layer prior to transparentization.

### INVENTION EXAMPLE 2

A blank Certipos® “Belgian Identity Card” polycarbonate-based card available from Certipost N.V. (Ninovesteenweg 196, B-9320 Erembodegem) was coated with the opaque porous composition given in Table 3 to a thickness of 100 μm and then dried at 60° C. for several minutes in a drying cupboard.

An ink-jetted image was applied to the surface of the opaque porous layer. Half of the resulting porous layer including part of the printed area was coated with the lacquer composition given in Table 2 of INVENTION EXAMPLE 1 to a thickness of 30 μm and the lacquer then cured by passing through a DRSE-120 conveyor from Fusion UV Systems Ltd. with a VPS/1600 UV lamp (speed 20 m/min, 50% UV power setting giving over a width of 20 cm and a length in the transport direction of 0.8 cm: a UV-A intensity of 1.176 W/cm², a UVB intensity of 0.466 W/cm² and a UVC intensity of 0.067 W/cm²). To obtain a complete curing three passes were necessary.

TABLE 3

| | | |
|---|---|---|
| Syloid ™ W300, a 47.5 wt % aqueous dispersion of colloidal | 75.6 | g |
| silica from GRACE GMBH | | |
| Poval PVA R3109, a silanol modified polyvinyl alcohol from | 2.3 | g |
| KURARAY | | |
| Catfloc ™ T2, a cationic polyelectrolyte from | 5.6 | g |
| CALGON EUROPE | | |
| Bronidox ™ K, a biocide from HENKEL | 0.3 | g |
| (5% solution in ethanol) | | |
| Citric acid | 0.3 | g |
| Small quantity of red-fluorescing polymer beads from Spectra | | |
| Systems Corporation | | |
| Polysol ™ EVA P-550, a 50% aqueous emulsion of an | 100 | g |
| ethylene-vinyl acetate-vinyl versatate copolymer from | | |
| SHOWA HIGH POLYMER CO. | | |
| Aerosol ™ OT, a surfactant from CYTEC | 1.5 | g |
| Tergitol ™ 4, a surfactant from UNION CARBIDE | 1 | g |
| Water to make | 1000 | g |

The beads are invisible in the non-transparentized area of the porous layer without irradiation at 366 nm with a UV-lamp. The beads are also not visible in the transparentized part of the porous layer due to the transparency of the beads. However, upon irradiating the lacquer-transparentized part of the porous layer with the UV-lamp the incorporated beads were clearly and sharply observable as a result of their red-fluorescence and moreover the printed image is surprisingly broken up by fluorescing spots from beads in the porous layer. It appears that the fluorescent beads surprisingly provide an obstacle to penetration of the printing inks deposited on the outermost surface of the porous receiving layer as they penetrate into the porous receiving layer.

This demonstrates that incorporation of fluorescent beads in transparentizable porous layers can be used as a covert security feature in lacquer-transparentized porous layers, the fluorescent beads being detectable as sharp well-defined images upon irradiation with UV-light.

### INVENTION EXAMPLES 3 to 5

A 100 μm thick sheet of transparent polyethylene terephthalate subbed with subbing layer 1 was doctor blade coated with the porous receiver layer dispersion to a wet thickness of 100 μm with the compositions given in table 4:

TABLE 4

| | EXAMPLE 3 | | EXAMPLE 4 | | EXAMPLE 5 | |
|---|---|---|---|---|---|---|
| Syloid ™ W300, a 47.5 wt % aqueous dispersion of | 32.16 | | 32.16 | | 32.16 | |
| colloidal silica from GRACE GMBH [g] | | | | | | |
| Poval PVA R3109, a silanol modified polyvinyl | 2.294 | | 2.294 | | 2.294 | |
| alcohol from KURARAY CO. [g] | | | | | | |
| Catfloc ™ T2, a cationic polyelectrolyte from | 1.391 | | 1.391 | | 1.391 | |
| CALGON EUROPE [g] | | | | | | |
| Bronidox ™ K, a biocide from HENKEL (5% solution | 0.065 | | 0.065 | | 0.065 | |
| in ethanol) [g] | | | | | | |
| Citric acid | 0.273 | | 0.273 | | 0.273 | |
| Fluorescent particles type Spectra Polystar long | 3.0 | | 0.3 | | 0.03 | |
| UV fluorescent security particles type PSP-1800- | | | | | | |
| 01 (53-75 μm particles) from Spectra Systems | | | | | | |
| Corporation [g] | | | | | | |
| Polysol ™ EVA P-550, a 50% aqueous emulsion of an | 10 | | 10 | | 10 | |
| ethylene-vinyl acetate-vinyl versatate copolymer | | | | | | |
| from SHOWA HIGH POLYMER CO. [g] | | | | | | |
| Aerosol ™ OT, a surfactant from CYTEC [g] | 0.03 | | 0.03 | | 0.03 | |
| Niaproof Anionic 4, a surfactant from NIACET [g] | 0.538 | | 0.538 | | 0.538 | |
| Water to make | 100 | g | 100 | g | 100 | g |

The porous layer-coated PET-films of INVENTION EXAMPLES 3 to 5 were dried in a drying cupboard at 90° C. for several minutes giving a dry layer thickness of ca. 20 μm. An ink-jet image was then printed on the dried porous layer with an EPSON PhotoStylus R800 ink-jet printer with proprietary aqueous pigment-based ink-jet inks. The printed porous layer was then transparentized by overcoating with the UV-curable composition given in Table 5 below:

TABLE 5

| Ingredient | | |
|---|---|---|
| Isobornyl acrylate | 41.62 | g |
| Sartomer SR 531 | 24.77 | g |
| Ebecryl 1039 | 17.838 | g |
| Ebecryl 11 | 9.91 | g |
| Initiator 16 | 4.95 | g |
| Perenol S Konz | 0.9 | g |
| Total | 100 | g |

The thereby transparentized printed porous layer was then UV-cured by means of a DRSE-120 conveyor from Fusion UV Systems Ltd. with a VPS/1600 UV lamp (speed 20 m/min, 50% UV power setting giving over a width of 20 cm and a length in the transport direction of 0.8 cm: a UV-A intensity of 1.176 W/cm², a UVB intensity of 0.466 W/cm² and a UVC intensity of 0.067 W/cm²). To obtain a complete curing three passes were necessary.

Since the particle size of the fluorescing beads was greater than the layer thickness of the porous layer and the dispersion of the beads was incomplete, there were beads not covered by the silica dispersion and hence fluorescence was observed prior to transparentization at all three concentrations. However, the fluorescing beads are clearly visible as separate particles and provide no absorption at all in the visible spectrum.

A frequent problem is that exposure of fluorescing agents to high intensity UV-light results in a reduction in luminescence. However, no reduction in luminescence was observed upon exposure to a UV-light emitting lamp between parts of the porous layer which had been transparentized with the UV-curable composition and cured in the DRSE-120 conveyor from Fusion UV Systems Ltd with a VPS/1600 UV lamp (speed 20 m/min, 50% UV power setting giving over a width of 20 cm and a length in the transport direction of 0.8 cm: a UV-A intensity of 1.176 W/cm², a UVB intensity of 0.466 W/cm² and a UVC intensity of 0.067 W/cm²).

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer.

2. The receiving layer configuration according to claim 1, wherein said pigment is an inorganic pigment.

3. The receiving layer configuration according to claim 2, wherein said inorganic pigment is silica.

4. The receiving layer configuration according to claim 1, wherein said binder is a water-soluble binder, a solvent-soluble binder or a latex.

5. The receiving layer configuration according to claim 4, wherein said receiving layer configuration comprises at least one latex in at least one constituent layer.

6. The receiving layer configuration according to claim 4, wherein at least one constituent layer of said receiving layer configuration comprises at least one pigment and at least one latex and the weight ratio of total pigment to total latex in said constituent layer is in the range of 3 to 6.5.

7. An information carrier precursor comprising a rigid sheet or a support and a receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer.

8. The information carrier precursor according to claim 7, wherein said rigid sheet or support comprises at least one layer and/or a multilayed laminate.

9. The information carrier precursor according to claim 7, wherein said rigid sheet or support has been preprinted with a security print.

10. A method for producing an information carrier comprising the steps of: providing an information carrier precursor comprising a rigid sheet or a support and a receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer; and printing an image or pattern on the porous outermost layer of the information carrier precursor by a conventional printing process using at least one liquid printing ink.

11. The method according to claim 10, wherein said process further comprises the step of applying said transparentizing lacquer to at least part of the areas of said outermost surface of said receiving layer configuration which are opaque thereby transparentizing at least in part the areas of said receiving layer configuration which are opaque and porous to which said transparentizing lacquer has been applied; and optionally curing said transparentizing lacquer.

12. The method according to claim 10, wherein said method further comprises the step of applying an image or pattern to the outermost layer of said receiving layer configuration using a conventional printing process.

13. The method according to claim 10, wherein said method further comprises the step of applying an image or pattern to said opaque parts of the outermost layer of said receiving layer configuration using a conventional printing process.

14. The method according to claim 12, wherein said conventional printing process is ink-jet printing.

15. The method according to claim 10, wherein the refractive index of said pigment and the refractive index of said lacquer differ by no more than 0.04.

16. The method according to claim 10, wherein the refractive index of said pigment and the refractive index of said lacquer differ by no more than 0.02.

17. An information carrier obtained by a printing process comprising the steps of: providing an information carrier precursor comprising a rigid sheet or a support and a receiving layer configuration having an image-receiving side and a non-image-receiving side, said receiving layer configuration comprising at least one pigment and at least one binder, wherein at least one constituent layer of said receiving layer configuration is opaque; at least the outermost layer on said image-receiving side or a layer in diffusive contact with said outermost layer on said image-receiving side is opaque and porous; said at least one opaque layer and/or at least one layer between the opaque layer nearest to said image-receiving side and said non-image-receiving side comprises luminescent fibres and/or luminescent beads; and said receiving layer configuration is capable of being rendered substantially transparent by penetration by a lacquer; and printing an image or pattern on the porous outermost layer of the information carrier precursor by a conventional printing process using at least one liquid printing ink.

18. The information carrier according to claim 17, wherein said image or pattern is printed by ink-jet printing and the resulting ink-jet image upon exposure to a non-visible light source is interrupted by luminescing luminescent fibres and/or luminescent beads and/or luminescent particles.

19. The information carrier according to claim 17, wherein said information carrier is an identification card selected from the group consisting of an identity card, a security card, a driver's license card, a social security card, a membership card, a time registration card, a bank card, a pay card, a credit card and a passport page.
